(19) United States
(12) Patent Application Publication
(10) Pub. No.: US 2006/0278258 A1
(43) Pub. Date: Dec. 14, 2006

(54) DISHWASHER

(75) Inventors: Seyfettin Kara, Spenge (DE); Darko Radusin, Bielefeld (DE)

Correspondence Address: DARBY & DARBY P.C., P. O. BOX 5257, NEW YORK, NY, 10150-5257, US

(73) Assignee: Miele & Cie. KG, Guetersloh (DE)

(21) Appl. No.: 11/422,733

(22) Filed: Jun. 7, 2006

(30) Foreign Application Priority Data
Jun. 8, 2005 (DE) 10 2005 026 558.8
Mar. 14, 2006 (DE) 10 2006 012 080.9

(51) Int. Cl. B08B 3/00; B08B 3/12

(52) U.S. Cl. 134/56 D; 134/58 D; 134/198; 134/172

(57) ABSTRACT

A dishwasher includes a tub, a spraying device and a washing liquid supply device. The spraying device is disposed in the tub and includes a number of spray nozzles. The spraying device is rotatable about a first axis, the first axis being approximately vertical when the dishwasher is in a working position. The washing liquid supply device supplies the spraying device with washing liquid. The spraying device includes a rotatable spray control device that opens and closes a flow path of washing liquid to the spray nozzles so as to provide pulsed spray jets.

Priority is claimed to German patent applications DE 10 2005 026 558.8, filed Jun. 8, 2005, and DE 10 2006 012 080.9, filed Mar. 14, 2006, the entire subject matters of which are hereby incorporated by reference herein.

The invention relates to a dishwasher with a tub, in which at least one spraying device fitted with spray nozzles is mounted so as to rotate around an axis that is at least approximately vertical in the position in which the dishwasher is used, said dishwasher having means to supply the spraying device or the spray nozzles with washing liquid.

### BACKGROUND

In conventional dishwashers, the spray jets that come out of the spraying nozzles consist of a sequence of drops. When they strike the surface of the dishes to be washed, the individual drops form a liquid surface that can impair the cleaning effect of the subsequent drops. For this reason, it is known from EP 0 659 381 B1 to operate a spraying device intermittently with an alternating sequence of spraying time periods and pauses. This is achieved by switching the circulation pump on and off. Swiss patent CH-PS 384 795 describes a dishwasher in which pulse-modulated liquid jets are used to clean items. The modulation is achieved by a hydraulic ram or else by valves or slides. EP 1 040 786 B1 discloses a dishwasher having a spray arm in which auxiliary nozzles are switched on intermittently in addition to the main nozzles. The auxiliary nozzles are opened and closed by means of a spring mechanism that is actuated through an increase in the circulation pump pressure.

Moreover, prior-art dishwashers (EP 0 943 282 B1) having several spray arms also make use of so-called alternating or interval washing in which only one of the spray arms is supplied with washing liquid at a time while the feed to the other arms is blocked. Since this reduces the amount of liquid in the liquid lines leading to the spray arms, the possibility exists of operating the circulation pump at a smaller liquid throughput rate, thus saving water.

Moreover, the prior art also describes spray arms that are configured in such a way that they pay special attention to problem areas in the dishwasher tub. Reference is made here, for instance, to EP 0 974 302 B1, which discloses a cleaning device for a dishwasher whose spray arm has so-called corner spray nozzles. Another solution from the state of the art is known, for example, from German Utility Model 297 18 777. This publication discloses that a main dishwashing arm as well as an auxiliary dishwashing arm, which is rotatably attached to the main dishwashing arm, brushes along the wall of the dishwasher and is guided through the corner areas under the influence of the centrifugal force. These are, for example, solutions from the state of the art that are intended to improve the cleaning results especially in problem areas in the dishwasher tub. These solutions according to the state of the art increase the spatial efficiency of the cleaning but not the efficiency of the individual spray jets that come out of the spray arm and act on the dishes during the cleaning procedure.

### SUMMARY OF THE INVENTION

Therefore, it is an object of the present invention to provide a modulation of the spray jets in a simple manner in a dishwasher, thereby attaining a better cleaning effect while concurrently saving water.

The present invention provides a dishwasher including a tub, a spraying device and a washing liquid supply device. The spraying device is disposed in the tub and includes a plurality of spray nozzles. The spraying device is rotatable about a first axis, the first axis being approximately vertical when the dishwasher is in a working position. The washing liquid supply device is configured to supply the spraying device with washing liquid. The spraying device includes a rotatable spray control device configured to open and close a flow path of washing liquid to the spray nozzles so as to provide pulsed spray jets.

The interruption of the spray jets in the manner according to the invention improves the cleaning result in a simple manner in that it reduces the liquid surface formed on the dishes to be cleaned. Such a liquid surface can diminish the cleaning effect of the spray jet. Moreover, with the present invention water is saved without the occurrence of “dead zones” where the dishes are less exposed to the spraying. Since the alternating interruption of the spray jets causes their pressure to be increased, dirt adhering to the dishes is removed more effectively, so that a better cleaning result is achieved despite the fact that water is being saved. Pulsed spray jets act upon the dishes to be cleaned, which leads to a more efficient cleaning operation. Here, the spraying device is supplied by the circulation pump so that, as a result of the changed rotational speed of the circulation pump, the size or the interval of the drops can be quickly changed. Volume flows are created in the spraying device when the circulation pump is operated. These volume flows are employed to bring about functional changes and/or movements in the spraying device. According to the invention, by means of a certain volume flow, a functional element is moved and/or driven from one position into the other. This change in position serves to influence the parameters of the spray jets. Due to the fact that the spray arm is provided with rotating means that cause the spray nozzles to open and close so as to create pulsed spray jets, the jet shape, the jet speed, the jet type, the jet direction, the spray drop interval and the nozzle position are all influenced. In this context, the means are rotated exclusively by the washing liquid that is circulated in the dishwasher tub by the circulation pump.

In a first advantageous embodiment, the means are arranged in the area of the axis of rotation of the spraying device and they can be rotated in the plane of the spraying device at a rotational speed that differs from that of the spraying device. This allows for a simple construction and the rotating capacity of the spraying device is not impaired.

In this embodiment, the means comprise at least one cylindrical closing element having passage openings in the outer wall, whereby the cylinder axis coincides with the axis of rotation. Owing to its simple construction, such a closing element can be used in a serially produced spray arm without a need for major structural changes.

It is advantageous for the openings in the outer wall of the closing element to be positioned in such a way relative to the channels connected to the spray nozzles that only the path of the washing liquid to some of the channels is interrupted during a relative rotation between the closing element and the spraying device. A simultaneous closing of all of the nozzles would cause the entire circulating liquid mass to be decelerated, so that the energy of the moved liquid column and thus its cleaning effect would be reduced. Besides, the slow rotation of the closing element brought about by this deceleration would increase the static friction, thus promoting jamming of the element. In a simple manner, the alternating closing and opening in the case of a spray arm having precisely two spray arm halves is achieved by an odd number of closure surfaces. In this context, it is advantageous for the closing element to have three closure surfaces. As a result, the force brought to bear by the pressure of the washing liquid is more uniformly distributed over the individual closure surfaces, thus avoiding tilting of the closing element and resultant jamming. Moreover, the modulation frequency is raised which, in turn, enhances the cleaning performance.

According to a second embodiment, the means comprise a cylindrical body whose circumference is provided with cutouts that lie in the area that overlaps with the spray nozzles arranged on the spray arm. Here, the axis of rotation of the body is arranged parallel to the main direction in which the spray arm extends.

The closing element or the body can be driven by an electric motor, by one or more magnets or else by the rotation of the spraying device by means of a gear that is operatively connected to said spraying device.

In an advantageous embodiment, the closing element or the body is made to rotate by the liquid flowing to the spray nozzles. Consequently, no additional drives are needed. Here, a turbine can be employed as the drive. Thus, all that needs to be provided on the spray arm is a space to accommodate the closing element or the body; no other structural modifications are necessary in order to realize the drive.

The turbine blades can be situated on a shaft that extends through the center of the closing element or the body. However, it is advantageous to arrange the turbine blades inside the closing element or the body since then, the space needed to accommodate the element is kept small. Moreover, with this embodiment, the closing element or the body can be mounted, or supported, on one side which, in turn, reduces the complexity of the components. Here, it is advantageous for a stub shaft arranged on the closing element to run through a sliding bearing arranged in the center of the spraying device.

### BRIEF DESCRIPTION OF THE DRAWINGS

The drawings show embodiments of the present invention in schematic form that will be described in greater detail below. The following are shown:

FIG. 1 an exploded view of a spray arm 7 constructed according to the invention;

FIG. 2 a simplified schematic depiction of a dishwasher 1 with a tub 2 and spray arms 7;

FIG. 3 a top view of a sectional diagram of a spray arm 7 constructed according to the invention;

FIG. 4.1 a longitudinal section through a spray arm 7, with a closing element that is moved magnetically;

FIG. 4.2 a top view of a partial section of the spray arm 7 according to FIG. 4.1;

FIG. 5.1 a longitudinal section through a spray arm 7, with a closing element that is moved by a turbine;

FIG. 5.2 a top view of a partial section of the spray arm 7 according to FIG. 5.1;

FIG. 6.1 a longitudinal section through another spray arm 7, with a closing element that is moved by a turbine;

FIG. 6.2 a top view of a partial section of the spray arm 7 according to FIG. 6.1;

FIG. 7 an overview of closing elements with differently shaped closure surfaces and openings;

FIG. 8 an advantageous embodiment of a closing element with reference to a three-dimensional model;

FIG. 9 a perspective view of another embodiment with a body having a horizontal axis of rotation;

FIG. 10 a detailed view of the rotation drive by means of turbine blades;

FIG. 11 another variant of the rotation drive by means of an angular gear;

FIG. 12 a sectional side view through a spray arm with an integrated, cylindrical body; and

FIGS. 13, 14 other variants of bodies having a horizontal axis of rotation.

### DETAILED DESCRIPTION

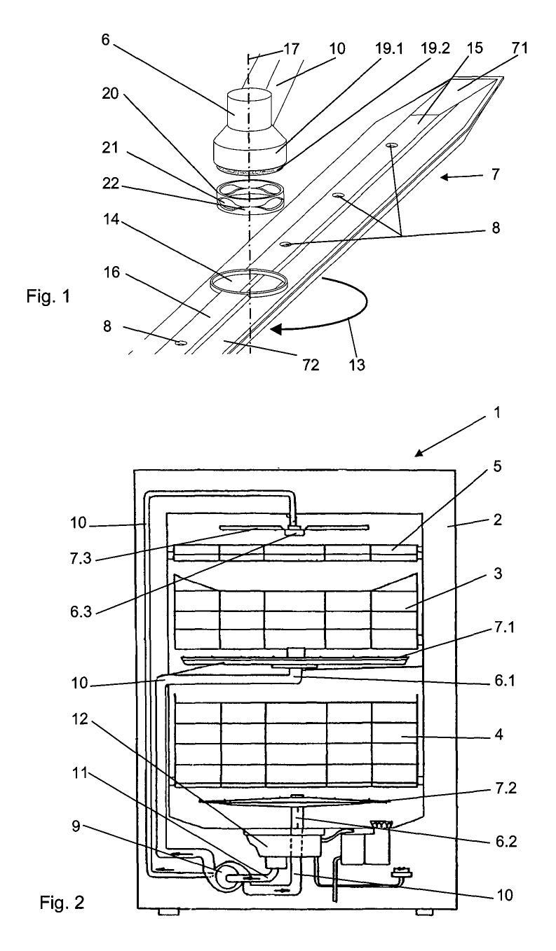

FIG. 1 shows a spray arm 7 constructed according to the invention, belonging to a household dishwasher 1 shown in greater detail in FIG. 2. The dishwasher 1 has two dish racks 3 and 4 arranged one above the other in a rectangular dishwasher tub 2, and a cutlery tray 5 is located above the upper rack 3. Alternatively, the cutlery basket can be integrated into one of the racks 3 and 4 instead of the cutlery tray 5. Inside the rectangular dishwasher tub 2, underneath the upper rack 3 and the lower rack 4, spray arms 7.1 and 7.2, respectively, are rotatably mounted on liquid laden spray arm holders 6.1 and 6.2, respectively, while a third spray arm 7.3 rotates on another spray arm holder 6.3 above the cutlery tray 5.

The rotatable spray arms 7 are fitted with spray nozzles 8 (see FIG. 1) that are arranged in such a way that the entire load of dishes present in the racks 3, 4 and 5 are exposed to the washing liquid coming out of the spray nozzles 8. Here, the spray arms 7 are supplied with washing liquid by a circulation pump 9 via pipelines 10. The circulation pump 9 is connected via another pipeline 11 to the lowest point 12 of the cuboidal cleaning chamber 2 and it suctions the liquid that has accumulated there through generally known filters and once again pumps the liquid through the nozzles 8 of the spray arms 7, whereby a recoil force caused by the discharge of the washing liquid causes the spray arms 7 to rotate, which is indicated in FIG. 1 by the arrow 13.

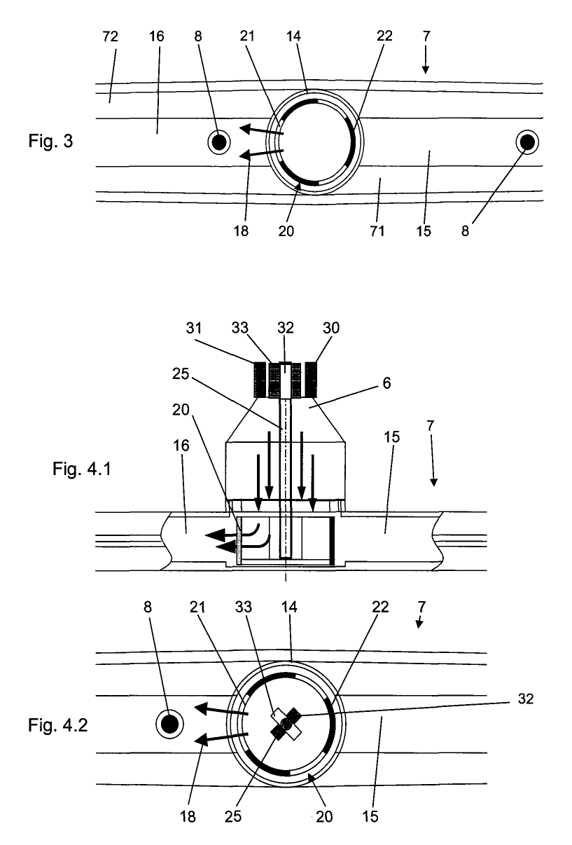

The liquid is fed to the spray arm 7 shown in a detailed view in FIG. 1 via a feed line 10 that makes a transition to the spray arm holder designated here with the reference numeral 6. The spray arm 7 itself is configured as a symmetrical hollow body and is mounted in a familiar manner so as to rotate on the holder 6. For this purpose, a swivel nut 19.1, in which a sliding bush 19.2 is secured, is screwed to the holder 6; the end of the sliding bush 19.1 that is visible in FIG. 1 and that protrudes towards the outside has an external thread (not shown here) that is screwed by an internal thread (likewise not shown here) to an accommodation space 14 of the spray arm. Inside the hollow body, channels 15 and 16 lead from the accommodation space 14 into both ends of the spray arm halves 71 and 72, and spray nozzles 8 are arranged on the top and bottom of the walls of said channels. A cylindrical, here annular, closing element 20 is inserted into the accommodation space 14. As a result, the cylinder axis of the closing element coincides with the axis of rotation of the spray arm 7, which is indicated by the broken line 17. The outer wall of the closing element 20 has openings 21 and, between those, closed areas 22 that function as closure surfaces, so that any relative movement between the spray arm 7 and the closing element causes the individual channels 15 and 16 to be alternatingly opened or closed. FIG. 3 shows the closing element 20 in a position in which the left-hand spray arm half 72 is opened while the right-hand half 71 is closed. The closure surfaces 22 are indicated here as a black annular section and the openings 21 as a white section. The emerging liquid is indicated by the arrows 18.

In order to prevent the two spray arm halves 71 and 72 from always being blocked in the same position, and thus to prevent the creation of “dead zones” that are not reached by the spray jets, the closing element 20 is moved, so that the closure surfaces end up in constantly changing spray arm positions in front of the channels 15 and 16. A moveable mounting is provided that allows the closing element to rotate at a speed that differs from the rotational speed of the spray arm 7.

The subsequent FIGS. 4.1, 4.2, 5.1, 5.2, 6.1 and 6.2 show spray arms 7 in which the closing element 20 in its active position rotates at a speed that differs from the rotational speed of the spray arm 7. Closing element 20 is rotated via rotation device 30 to 33. In the embodiment depicted in FIGS. 4.1 and 4.2, the rotation device 30 to 33 is made up of magnets 30 to 33. The spray arm 72 is coupled to a holder 6 that is fitted with oppositely poled magnets 30 and 31. An axis 25 connected to the closing element 20 extends into the holder 6 all the way into the area of these magnets 30 and 31. This end of this axis 25 has magnets 32 and 33 that are arranged crosswise and that are likewise oppositely poled. The closing element 20 itself is rotatably mounted inside the accommodation space 14 by a means that has been described elsewhere. When the spray arm 7 executes a rotational movement, the magnets 30 to 33 cause the closing element 20 to execute a pendulum movement. In this process, openings 21 and closure surfaces 22 are alternatingly moved in front of the channels 15 and 16, thus opening or closing the nozzles 8 present there.

In other embodiments the rotation device 30 to 33 is made up of an electric motor that rotates the closing element 20, or by a gear mechanism that rotates the closing element via the movement of the spray arm.

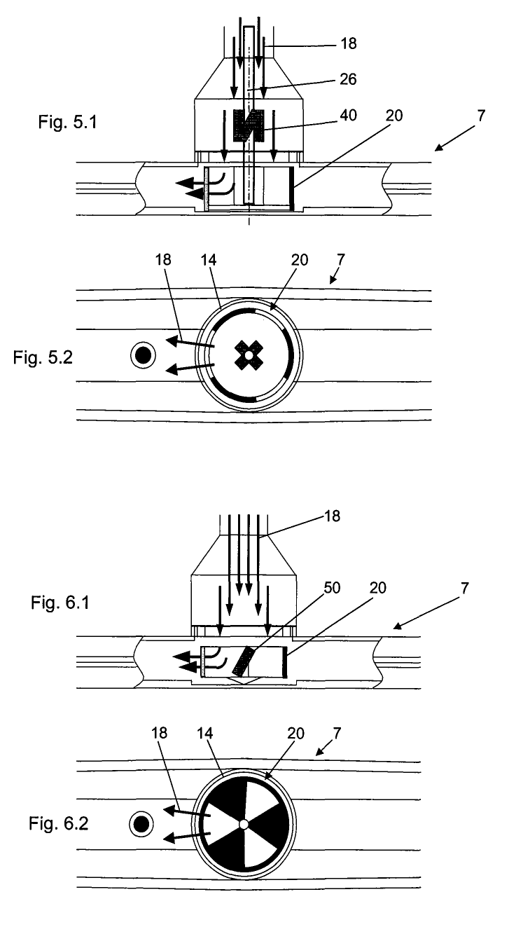

FIGS. 5.1 and 5.2 as well as 6.1 and 6.2 show spray arm variants in which the closing element 20 is likewise rotatably mounted in the accommodation space, where the element 20 is made to rotate by means of turbine blades 40 or 50. This has the advantage that a rotational movement is brought about by the flowing liquid 18, so that no additional, wear-prone drives are necessary. Here, the rotational speed is dependent on the throughput volume as well as on the dimensioning of the turbine blades 40 or 50 and it can be selected in such a manner that it differs from the speed of the spray arm 7. In the best case, the tilting direction of the turbine blades 40 or 50 is configured in such a way that a direction of rotation opposite to that of the spray arm 7 is established. The blades 40 can be arranged on a shaft 26 that extends through the center of the closing element 20; see FIGS. 5.1 and 5.2. With this arrangement, the shaft 26 also has to be bearing-mounted, which calls for additional effort and can give rise to blocking due to a possible tilting movement of the entire arrangement. For this reason, it is advantageous for the turbine blades 50 to be placed inside the closing element 20, as shown in FIGS. 6.1 and 6.2. They can then be integrally formed onto the closing element 20 which, on the one hand, simplifies the production and, on the other hand, means that only a small space is needed to accommodate the element.

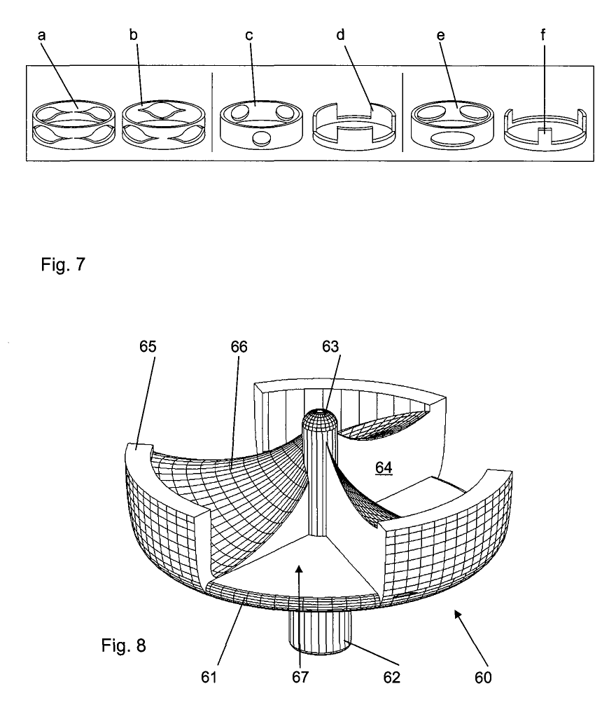

FIG. 7 shows various closing elements designated with the reference letters a to f, which differ from each other in terms of the number of openings and their shape and size. The element designated with the reference letter a has four openings, and thus also four closure surfaces, with two pairs facing each other. As a result, a simultaneous blockage of all of the spray nozzles is achieved in a spray arm 7 having two halves. The closing element designated with the reference letter b has three openings and closure surfaces. The symmetrical arrangement means that it is always only one half of a spray arm 7 having two halves that is blocked.

Element c shows a variant having relatively small openings, while closing elements d and e have openings that are the same width as the closure surfaces; f shows an element having very narrow closure surfaces. For the rest, the closing elements c and e, which have round openings or elliptical openings, differ from elements d and f, which have rectangular openings.

FIG. 8 shows a closing element 60 whose geometrical relationships have been optimized. It is configured as a one-piece component and is preferably made of plastic. For bearing purposes, a stub shaft 62 is formed onto a disk-shaped bottom part 61 in the axis of rotation, said stub shaft being inserted into a bore in the center of the accommodation space 14 (see FIG. 1). The bore functions as a sliding bearing, as a result of which the static friction between the closing element 60 and the spray arm 7 is reduced, thus allowing the element 60 to rotate in the first place. On the opposite side of the bottom part, the stub shaft 62 continues with a reduced diameter as a removal pin 63, thus facilitating installation and subsequent removal. Moreover, three symmetrically arranged bodies 64 rise from the edge of the bottom part 61 and these bodies form the closure surfaces 65 as well as the slanted turbine blades 66 needed for driving purposes. Openings 67 having a rectangular cross section have been left free between the closure surfaces, whereby the arc length of the closure surfaces 65 and of the openings 67 is about the same and amounts to approximately 60°.

The above-mentioned design of the closing element as described above entails the following advantages:

When used in a symmetrical construction, three closure surfaces 65 ensure the alternating closing of the spray arm halves 71 and 72 (see FIG. 3). An alternating blocking of one spray arm half 71 or 72 at a time means that mainly the liquid in the spray arm 7 is decelerated and then accelerated again. In contrast to this, a simultaneous blocking of both halves 71 and 72 causes the liquid in the entire feed line to be decelerated as well as accelerated. In this case, the spray arm 7 would have to have a very low angular velocity in order to achieve sufficient spray jet heights. This low rotational speed promotes jamming of the closing element 60. The above-mentioned alternating blocking of one spray arm half 71 or 72 is also achieved with closing elements having any odd number of openings or closure surfaces, but actual practice has shown that three openings 67 are especially conducive to attaining a uniform rotational movement; one single closing element would give rise to strong tilting moments that could also cause jamming. The extension of the closure surfaces 65 over an angle of approximately 60° translates into sufficiently long spraying pauses so as to achieve the above-mentioned improvement of the cleaning effect. If the number of closure surfaces is larger if the closing element is designed as shown in FIG. 7f, it would only be possible to attain very short spraying pauses, and moreover there would not be much space available to accommodate the turbine blades 66. The pitch and the surface area of the turbine blades 66 are dimensioned in such a way that a pulse sequence within the desired frequency range between 2 and 12 Herz can be achieved.

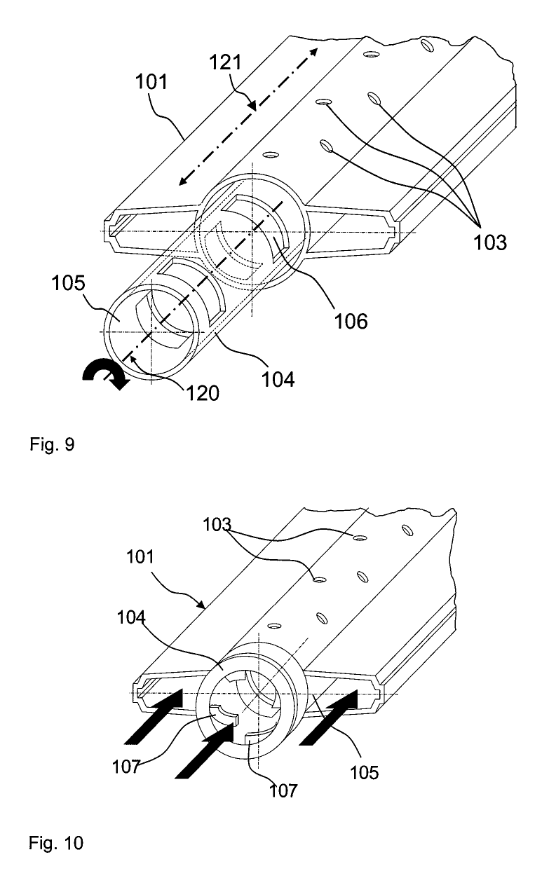

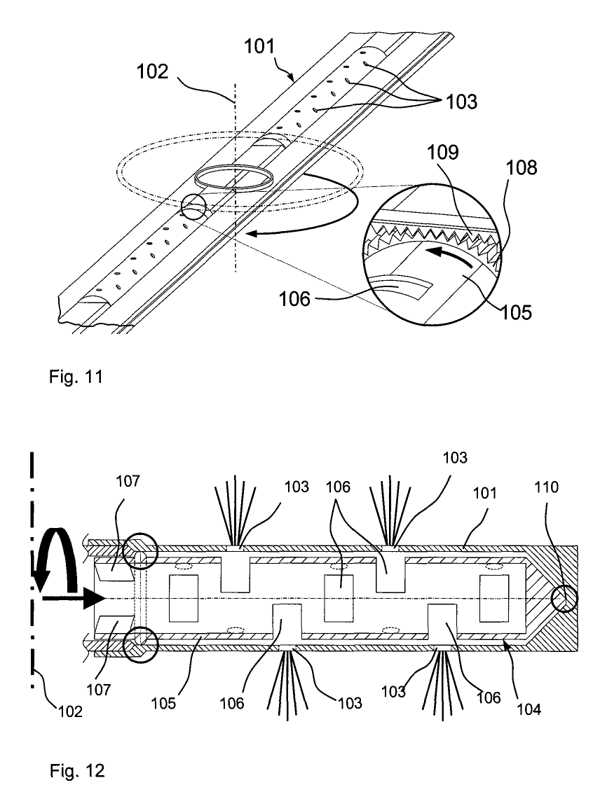

In the embodiments shown in FIGS. 9 to 14, instead of the closing element 20 or 60, cylindrical bodies 105 are employed whose axis of rotation 120 is arranged so as to be horizontal in the main extension direction 121 of the spray arm. FIG. 9 shows a perspective view of such an embodiment of a spray arm 101 in a dishwasher that is not depicted in greater detail. The spray arm 101 here is mounted so as to rotate around a vertical axis 102 in a dishwasher tub (see FIG. 11). The spray arm 101 is fitted with spray nozzles 103 that are supplied with washing liquid via a circulation pump (likewise not shown here). As can be seen in the perspective depiction of FIG. 9, rotating means 104 are provided in the spray arm 101, said means causing the spray nozzles 103 to open and close so as to create pulsed spray jets. Here, the washing liquid causes the means 104 to rotate. As can be seen in the perspective depiction of FIG. 9, but also clearly in FIG. 12, the means 104 comprise a cylindrical body 105 whose circumference is provided with cutouts 106 that lie in the area that overlaps with the spray nozzles 103 arranged on the spray arm 101. Consequently, the rotation of the cylindrical body 105 causes the nozzles 103 to be opened and closed again at certain time intervals. If the cylinder 105 rotates at a constant rotational speed, the nozzles 103 discharge pulsed water jets. These pulsed spray drops then clean the soiled dishes considerably more effectively.

In order to generate the rotation, turbine blades 107 are formed in the cylindrical body 105, here especially on the inlet side, such as depicted in detail in FIG. 10. Another variant of the drive for the cylindrical body 105 is shown in FIG. 11. Here, in order to generate the rotation, a toothed wheel rim 108 is arranged on the free end on the inlet side of the cylindrical body 105, said toothed wheel rim 108 being operatively connected to a toothed wheel rim 109 arranged on the fixed axis of rotation (102) of the feed line. Thus, when the spray arm 101 rotates around the vertical axis, this causes the cylindrical body 105 to turn along with it.

FIG. 12 once again illustrates how the individual spray nozzles 103 are opened and closed. The water enters the spray arm 101 in the direction indicated by the arrow and, in the manner depicted by the rotation arrow shown here, the individual nozzles 103 open when the individual cutouts 106 pass. This figure also especially shows the mounting of the cylindrical body 105, whereby here, in order to mount the cylindrical body 105, the latter acquires a conical shape at its end, with the cone tip 110 forming the bearing contact point in the spray arm 101. Here, only the tip 110 of the cone should be in direct contact with the stationary area. The front contact surface should be kept small through the configuration of the cone tip 110. This is achieved by means of the water flow. The water flow presses the rotating system against the cone tip 110 and only achieves radial contact in the rear area.

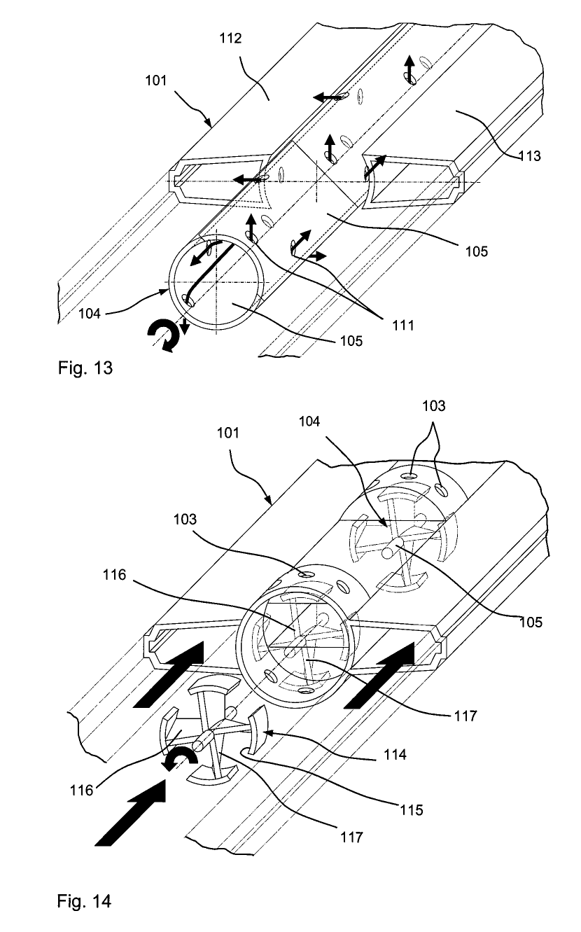

Another embodiment of the invention is shown in FIG. 13, whereby it is characterized in that the means 104 likewise comprise a cylindrical body 105 whose circumference is provided with outlet nozzles 111 arranged so as to be radially slanted in the cylinder wall, whereby the wing-like spray arm 101 laterally overlaps areas of the body 105, in other words, the cylindrical body 105 is mounted so as to rotate between the two spray arm legs 112 and 113. Here, the washing liquid jets coming out of the outlet nozzles 111 arranged at a slant automatically cause the body 105 to rotate, which is indicated in the figure by the arrows drawn with a thick line. In this embodiment, the inner cylinder 105 is configured in such a way that the spray nozzles 111 concurrently serve as driving nozzles. Here, the spray nozzles 111 are set at the greatest slant possible. The water that is now being sprayed through the offset nozzles 111 generates recoil forces that are distributed along the spray arm 101. These recoil forces cause the body 105 to rotate. Consequently, no additional drive elements are needed to rotate the body 105. Due to the positioned, rotating spray nozzles 111, the water jets cover a great deal of the space. Each nozzle 111 can differ in terms of its shape, number and type, for example, it can create a fanning jet, so that the risk of soiling is small since no dirt can collect between the rotating cylinder 105 and the spray arm 101. The movable openings of the rotating inner cylinder 105 permit the nozzles 111 to be configured in many different ways. For instance, the nozzle shape, nozzle type, number of nozzles and nozzle position on every cylinder cutout can be designed differently. At various points in time, the nozzles 111 of the spray arm 101 free different spray jets in different directions. This ensures that a larger space is covered by the water jets.

The embodiment shown in FIG. 14 is characterized in that the means 104 comprise individual rotating bodies 105 arranged along the extension of the spray arm 101, said bodies being fitted with closure baffles 114 that pass over outlet nozzle openings on the spray arm 101. For this purpose, the single body 105 has a cruciform shape and the closure baffles 114 are formed onto the legs 116 and 117. Advantageously, the closing elements 114 here comprise curved surface elements 115 that have been adapted to the shape of the spray arm. In order to keep the individual bodies 105 rotating here, the cruciform legs 116 and 117 are shaped so as to have the form of turbine blades. Several individual spray turbines, as shown in the example of FIG. 14, can generate an individual water jet coverage. Here, the closing elements 114 with the appertaining turbine are driven by means of the water flow. The closing elements 114 of the turbine can preferably be made, for example, of rubber. The inner surface of the cylinder is better sealed in this manner. In this case, it is particularly advantageous that the use of rubber material reduces the risk of dirt on the turbine blades. Moreover, due to the individual turbines, the nozzles 103 are individual and independent of each other. Different nozzles 103 can be arranged in each case, and they differ in terms of their shape, number and type. Furthermore, the drop size is dependent on the pressure and therefore can be adjusted individually by changing the rotational speed of the circulation pump.

What is claimed is:

1. A dishwasher comprising:
a tub;
a spraying device disposed in the tub and including a plurality of spray nozzles, the spraying device being rotatable about a first axis, the first axis being approximately vertical when the dishwasher is in a working position; and
a washing liquid supply device configured to supply the spraying device with washing liquid;
wherein the spraying device includes a rotatable spray control device configured to open and close a flow path of washing liquid to the spray nozzles so as to provide pulsed spray jets.

2. The dishwasher as recited in claim 1 wherein the spray control device is disposed in an area of the first axis and is rotatable in a plane of rotation of the spraying device at a rotational speed different from a rotational speed of the spraying device.

3. The dishwasher as recited in claim 2 wherein the spray control device includes at least one substantially cylindrical closing element having a plurality of passage openings in an outer wall thereof, the cylinder defining a second axis that coincides with the first axis.

4. The dishwasher as recited in claim 3 wherein:
the plurality of spray nozzles includes a first and a second spray nozzle;
the spraying device includes a first channel connected to the first spray nozzle and a second channel connected to the second spray nozzle; and
the passage openings are disposed so that, as a function of a relative rotation between the closing element and the spraying device, a first path of the washing liquid to the first channel is interrupted when a path of the washing liquid to the second channel is open.

5. The dishwasher as recited in claim 4 wherein the spraying device includes a spray arm having a first and a second spray arm half, and the closing element includes an odd number of closure surfaces.

6. The dishwasher as recited in claim 5 wherein the closing element has three closure surfaces.

7. The dishwasher as recited in claim 1 wherein:
the spraying device includes a spray arm, the plurality of nozzles being disposed in the spray arm; and
the spray control device includes a cylindrical body having a plurality of cutouts provided at a circumference thereof, the cutouts being disposed in an area that overlaps with the spray nozzles.

8. The dishwasher as recited in claim 7 wherein the spray arm extends along a main arm axis, an axis of rotation of the cylindrical body being parallel to the main arm axis.

9. The dishwasher as recited in claim 1 wherein the spray control device includes at least one substantially cylindrical closing element having a plurality of passage openings in an outer wall thereof, the cylinder defining a second axis that coincides with the first axis, and further comprising an electric motor configured to drive the closing element.

10. The dishwasher as recited in claim 1 wherein:
the spraying device includes a spray arm, the plurality of nozzles being disposed in the spray arm; and
the spray control device includes a cylindrical body having a plurality of cutouts provided at a circumference thereof, the cutouts being disposed in an area that overlaps with the spray nozzles;
and further comprising an electric motor configured to drive the cylindrical body.

11. The dishwasher as recited in claim 1 wherein the spray control device includes at least one substantially cylindrical closing element having a plurality of passage openings in an outer wall thereof, the cylinder defining a second axis that coincides with the first axis, and further comprising at least one magnet configured to drive the closing element.

12. The dishwasher as recited in claim 1 wherein the spray control device includes at least one substantially cylindrical closing element having a plurality of passage openings in an outer wall thereof, the cylinder defining a second axis that coincides with the first axis, and further comprising a gear operatively connected to the spraying device and configured to drive the closing element by a rotation of the spraying device.

13. The dishwasher as recited in claim 1 wherein:
the spraying device includes a spray arm, the plurality of nozzles being disposed in the spray arm; and
the spray control device includes a cylindrical body having a plurality of cutouts provided at a circumference thereof, the cutouts being disposed in an area that overlaps with the spray nozzles;
and further comprising a gear operatively connected to the spraying device and configured to drive the cylindrical body by a rotation of the spraying device.

14. The dishwasher as recited in claim 1 wherein the spray control device includes at least one substantially cylindrical closing element having a plurality of passage openings in an outer wall thereof, the cylinder defining a second axis that coincides with the first axis, the closing element being rotatable by a flow of the washing liquid flowing to the spray nozzles.

15. The dishwasher as recited in claim 1 wherein:
the spraying device includes a spray arm, the plurality of nozzles being disposed in the spray arm; and
the spray control device includes a cylindrical body having a plurality of cutouts provided at a circumference thereof, the cutouts being disposed in an area that overlaps with the spray nozzles, the cylindrical body being rotatable by a flow of the washing liquid flowing to the spray nozzles.

16. The dishwasher as recited in claim 1 wherein the spray control device includes at least one substantially cylindrical closing element having a plurality of passage openings in an outer wall thereof, the cylinder defining a second axis that coincides with the first axis, and further comprising a turbine configured to drive the closing element.

17. The dishwasher as recited in claim 1 wherein:
the spraying device includes a spray arm, the plurality of nozzles being disposed in the spray arm; and
the spray control device includes a cylindrical body having a plurality of cutouts provided at a circumference thereof, the cutouts being disposed in an area that overlaps with the spray nozzles;
and further comprising a turbine configured to drive the closing element.

18. The dishwasher as recited in claim 16 wherein the turbine includes a plurality of blades disposed on a shaft extending through a center of the closing element.

19. The dishwasher as recited in claim 17 wherein the turbine includes a plurality of blades disposed on a shaft extending through a center of the cylindrical body.

20. The dishwasher as recited in claim 16 wherein the turbine includes a plurality of blades disposed inside the closing element.

21. The dishwasher as recited in claim 17 wherein the turbine includes a plurality of blades disposed inside the cylindrical body.

22. The dishwasher as recited in claim 16 wherein the closing element is supported on a side thereof.

23. The dishwasher as recited in claim 17 wherein the cylindrical body is supported on a side thereof.

24. The dishwasher as recited in claim 20 further comprising a sliding bearing disposed at a center of the spraying device and a stub shaft disposed on the closing element, the stub shaft being received by the sliding bearing.

25. The dishwasher as recited in claim 22 further comprising a sliding bearing disposed at a center of the spraying device and a stub shaft disposed on the closing element, the stub shaft being received by the sliding bearing.

26. The dishwasher as recited in claim 1 wherein:
the spraying device includes a spray arm, the plurality of nozzles being disposed in the spray arm; and
the spray control device includes a cylindrical body having a plurality of cutouts provided at a circumference thereof, the cutouts being disposed in an area that overlaps with the spray nozzles, the cylindrical body including a conical shape at an end thereof, a cone tip of the conical shape forming a bearing contact point in the spray arm for mounting the cylindrical body.
